(19) United States
(12) Patent Application Publication
(10) Pub. No.: US 2019/0135596 A1
(43) Pub. Date: May 9, 2019

(54) LINE BRAKE

(71) Applicant: Wenger Corporation, Owatonna, MN (US)

(72) Inventors: Christopher D. Whaley, Phoenix, NY (US); Paul W. Zagajeski, Liverpool, NY (US); Patrick J. Finn, Syracuse, NY (US)

(21) Appl. No.: 16/183,292

(22) Filed: Nov. 7, 2018

Related U.S. Application Data
(60) Provisional application No. 62/582,602, filed on Nov. 7, 2017.

(51) Int. Cl. B66D 5/16

(52) U.S. Cl. CPC B66D 5/16

(57) ABSTRACT

An innovative brake for use with a hoist assembly is disclosed. The brake incorporates a fixed jaw attached to a support frame and a moving jaw which is allowed to traverse along angular features to permit sufficient spacing between jaws allowing the rope, cable, or wire to pass through safely without premature engagement of the brake devices system.

### CROSS-REFERENCE TO RELATED APPLICATION

The present application claims the benefit of U.S. Provisional Application No. 62/582,602, filed Nov. 7, 2017, which is hereby incorporated herein in its entirety by reference.

### TECHNICAL FIELD

The present invention relates to a brake for use with a hoist assembly. Specifically, the present invention is a line brake for use with a hoist.

### BACKGROUND

The use of hoists for lifting and lowering items is well known. Known in the art are several mechanisms used in braking for a hoist. Some braking mechanisms apply friction directly to the hoist drum to slow/stop rotation of the drum. Another means of braking involves applying friction to the drive shaft of the hoist to slow/stop rotation. Braking of hoists may also be accomplished by applying friction directly to the hoist line.

A drawback of prior art hoist brakes is the need for early engagement of the brake device to stop the hoist line at a desired location. Another drawback of prior art hoist brakes is the need to manually adjust the brake system over time due to wear and alignment issues due to vibration and stresses on the hoist. Many prior art hoist brakes do not include built-in failsafe structures and require secondary emergency braking systems to deal with issues such as power loss. Prior art hoist brakes were directed at solving some of these issues, but in doing so either ignored other issues or exacerbated the other issues.

While prior art devices have attempted to address the various drawbacks of hoist brake systems, there still exists the need for improved performance of hoist brakes that also provides improved safety while minimizing maintenance.

### SUMMARY

An innovative brake for use with a hoist assembly is disclosed. The brake incorporates a fixed jaw attached to a support frame and a moving jaw which is allowed to traverse along angular features to permit sufficient spacing between jaws allowing the rope, cable, or wire to pass through safely without premature engagement of the brake devices system.

The brake eliminates the need for early engagement of the brake to stop the line at a specific location and incorporates multiple adjustment elements that allow for improved accuracy in gap spacing between a fixed jaw and a moving jaw. These adjustment elements also allow for compensation as the jaw profile changes due to wear from normal use. These adjustment elements also allow for tuning the brake for specific operating conditions and for variations in the type of line used (cable, rope, wire, chain). The configuration of the invention immediately engages the brake when there is a loss of power to the system. The configuration also utilizes mechanical spring force to bring the moving jaw into the fixed jaw when there is no power provided to the brake, which causes contact via friction with the line between the two jaws.

The design of the present invention relies upon a specific angle of the moving jaw to provide a clamping force between the moving jaw and fixed jaw that is directly proportional to the surface area of the contact between the jaws. Clamping force of the brake is also based on the brake jaw material, brake jaw profile, and the type and condition of the line. The fixed jaw of the brake incorporates a groove through which the line runs to maximize surface contact between the jaw and the line. The brake also provides an individual brake assembly for each line and requires less than 1.5 g-force to stop the line.

The above summary is not intended to describe each illustrated embodiment or every implementation of the subject matter hereof. The figures and the detailed description that follow more particularly exemplify various embodiments.

### ADVANTAGES OF THE INVENTION

Eliminates need for early engagement of brake device system to stop a desired location.
Fixed jaw has multiple adjustment features which enables accurate gap spacing between the fixed and moving jaws.
Allows compensation and correction for jaw profile and wear due to normal usage.
Allows tuning of hoist assembly to individual system conditions and rope, cable, wire variations.
Moving jaw is held open by an expansion mechanism to hold the jaws open during normal operation.
Loss of power immediately engages brake system.
Mechanical force of spring mechanism between moving jaw and frame body actuates the moving jaw into contact with rope, cable, or wire. Resultant contact generates friction and drag, which pulls the moving jaw into the fixed jaw.
Predetermined angle of jaws results in clamping force between jaws directly proportional to the surface area of contact between the fixed and moving jaws.
Clamping force is also proportionate to the surface area in direct contact with rope, cable, wire during engagement as well as the brake jaw material, brake jaw profile, and condition of the rope, cable, wire.
Fixed jaw incorporates groove feature to maximize surface contact while maintaining the required clamping forces to achieve full stopping force.
Each rope, cable, wire within the hoist assembly has an individual brake assembly.
Provides stopping with less than 1.5 g-force.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of the line brake according to an embodiment of the invention.

FIG. 2 is a front view of the line brake according to an embodiment of the invention.

FIG. 3 is right side view of the line brake of FIG. 2

FIG. 4 is a rear view of the line brake of FIG. 2.

FIG. 5 is a cross-sectional view of the line brake of FIG. 2 taken along line A-A.

FIG. 6 is a cross-sectional view of the line brake of FIG. 3 taken along line B-B.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

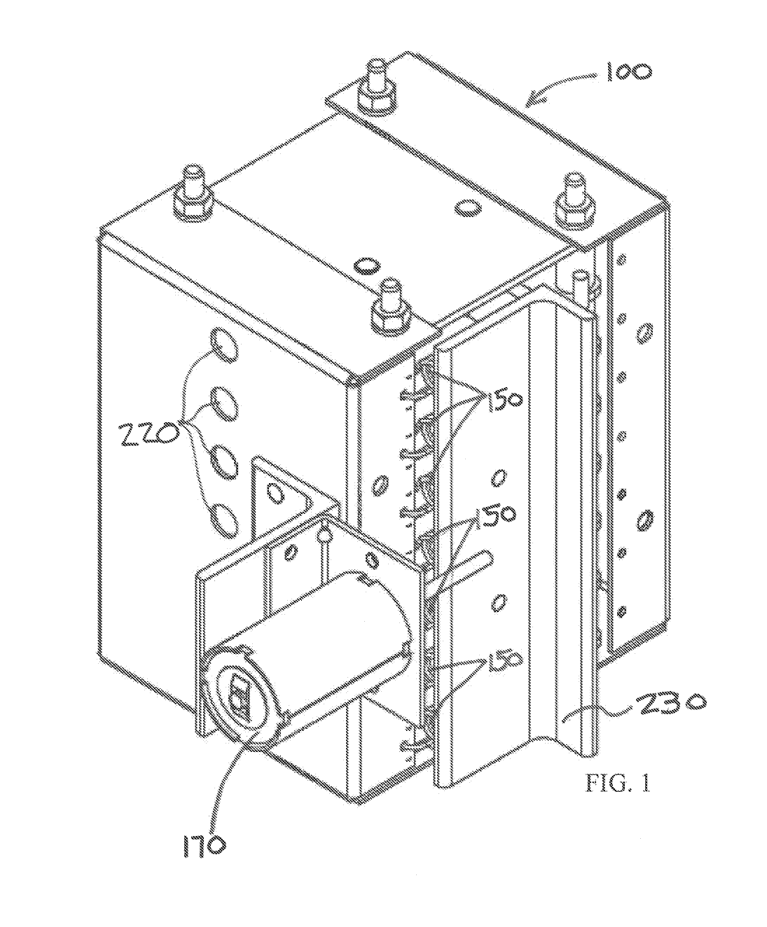

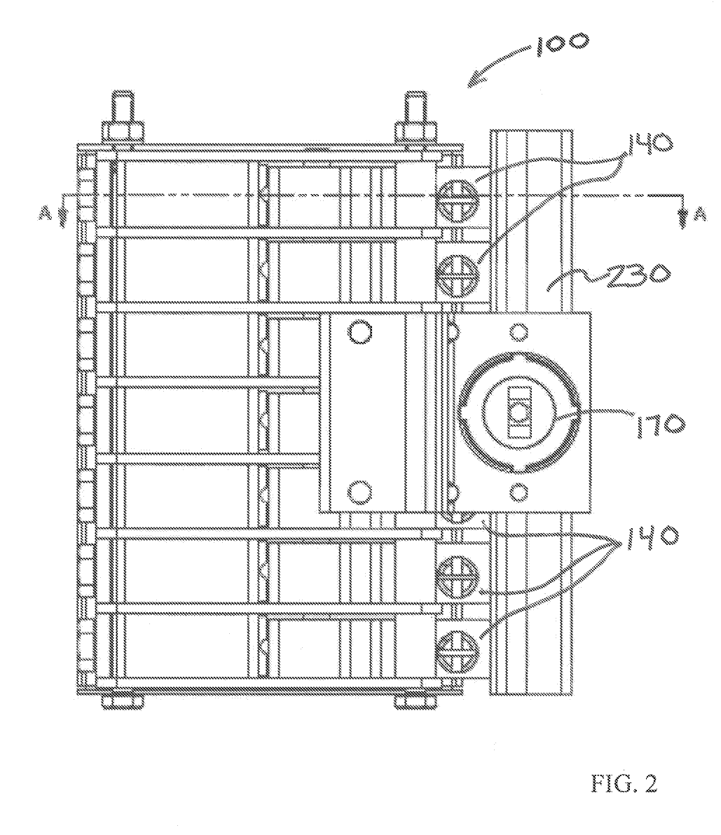

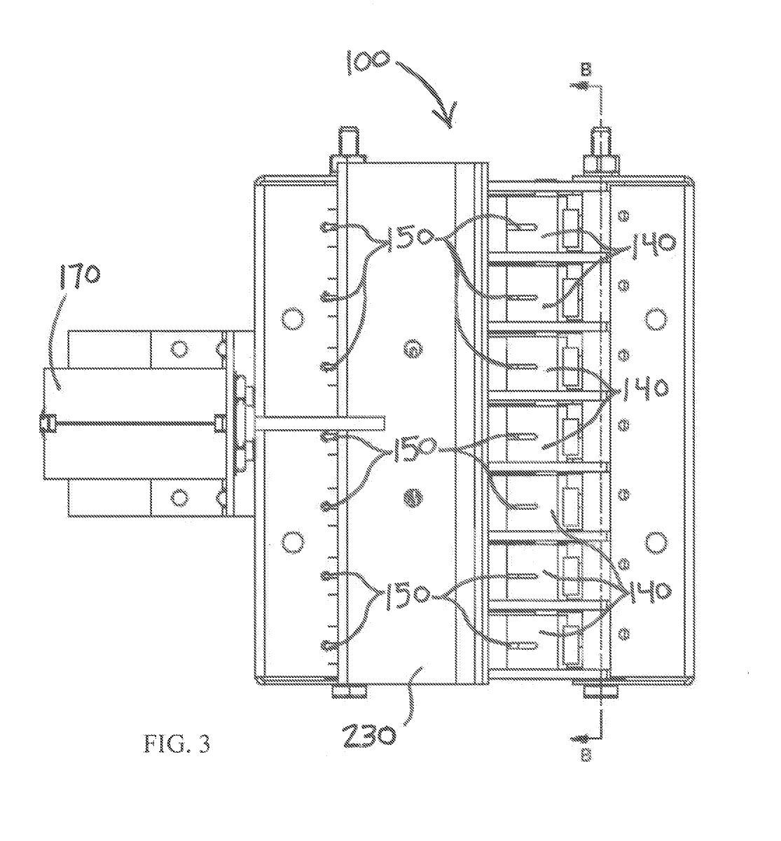

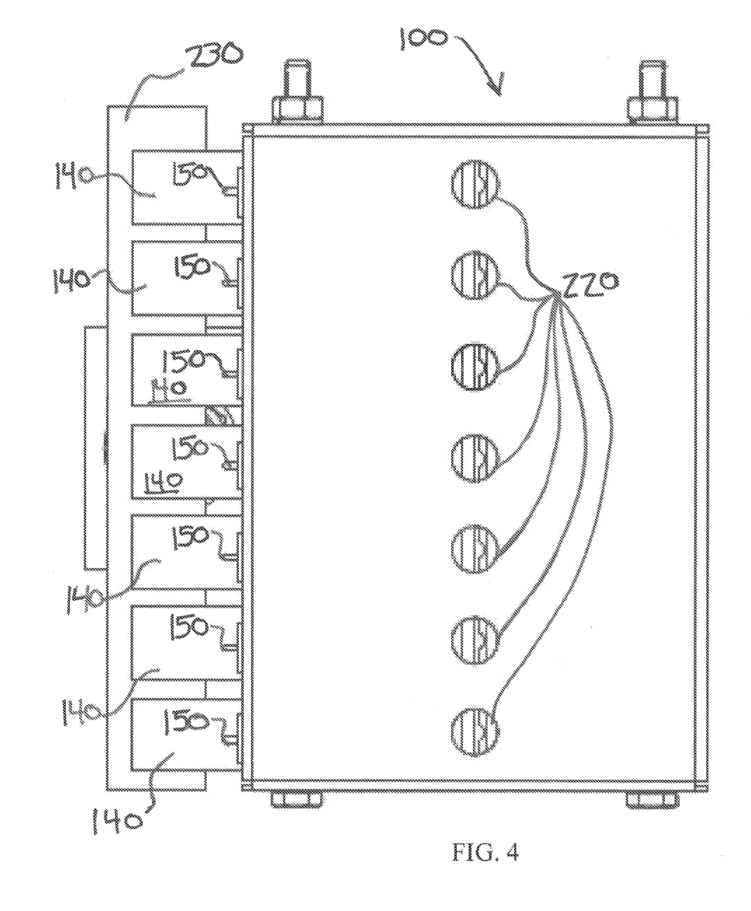

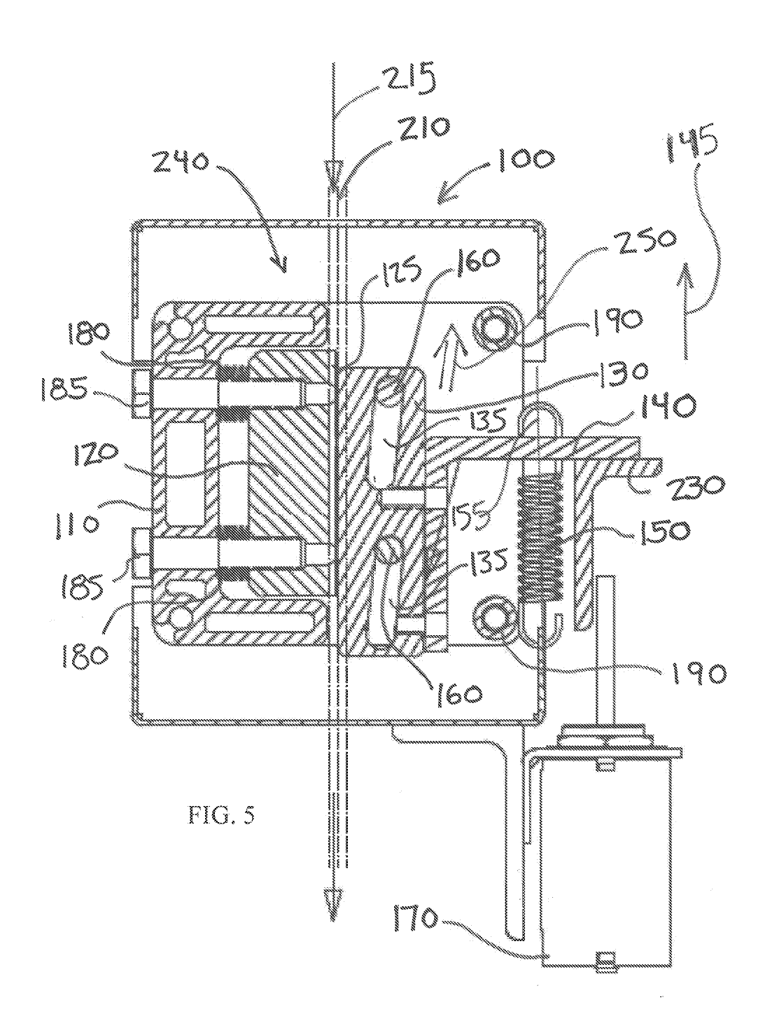

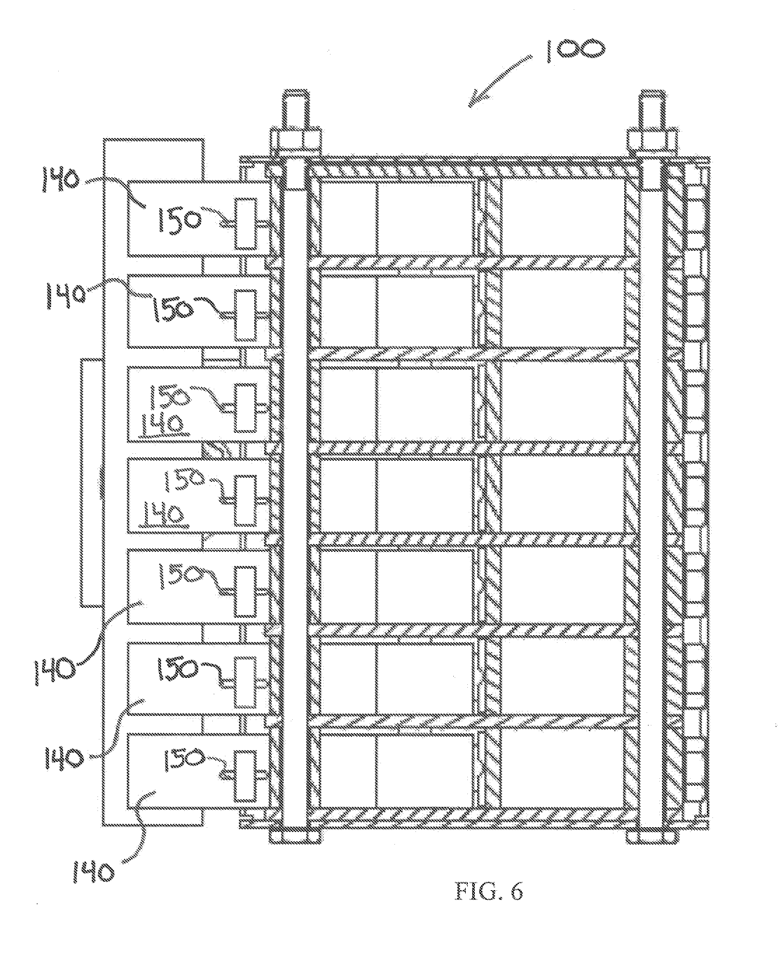

A hoist line brake according to an embodiment of the invention is depicted generally in FIG. 1 with reference numeral 100. In the embodiment depicted in FIG. 1, the hoist line brake consists of individual brakes 240 (see FIG. 5) for seven lines. The invention contemplates any number of individual brakes 240. Each individual brake 240 comprises identical parts, but is actuated by a single activator 170 that moves an activator bar 230 and releases the individual brakes. While the embodiment of the hoist line brake 100 depicted in FIGS. 1-6 have a single activator 170, the invention also contemplates having individual activators for each individual line brake 240. When the activator 170 is triggered, the individual brake 240 acts to release its hoist line 210 having a path 215 through the brake 240. As illustrated in FIGS. 2-4, the seven individual brakes 240 are stacked and aligned to allow the single activator 170 to control all the individual brakes 240.

FIG. 5 presents a cross section of hoist line brake 110 that illustrates the components for each individual brake 240. Each individual brake 240 is comprised of a fixed jaw 120 and a moving jaw 130. A biasing element (such as a tension spring) 150 having a longitudinal axis 155 keeps the moving jaw 130 in a non-activated position (i.e., the mechanical force of the biasing element 150 brings the moving jaw 130 toward the fixed jaw 120, creating friction on the hoist line 210). Weight or force on the end of the hoist line 210 further acts to generate friction and drag and pull the moving jaw 130 toward the fixed jaw 120. The fixed jaw 120 may have a groove on its clamping surface 125 that is sized to maximize the amount of its surface contact with the hoist line 210, increasing friction and clamping force produced by the moving jaw 130.

When the individual brake 240 is activated by an activator 170 (e.g., a solenoid pusher), an activator bar 230 pushes against each individual brake's pusher 140, which counteracts the force of the biasing element 150 to shift the moving jaw 130 along a path 250 away from the fixed jaw 120. This movement releases the friction caused by the clamping of the fixed jaw 120 and the moving jaw 130, and allows the hoist line to travel in either direction. The activator 170 can be regulated to move the activator bar 230 incrementally to allow complete release of the hoist line 210, maximum clamping (stopping) of the host line 210, or any amount in between. Loss of power causes the activator 170 to cease pushing the brake pusher 140 and automatically engages the brake 240.

A novel aspect of the invention is the use of one or more jaw slots 135, each with associated guide rod 160, that controls the path 250 of the moving jaw 130. This configuration allows a more controlled release of the friction caused by the jaws 120, 130 as compared to existing hoist brakes that rely on perpendicular force to create friction on the hoist line 210. This configuration also eliminates the need for early engagement of the line brake 100 to stop the hoist line 210 at a desired location. It further results in increasing friction and drag on the hoist line 210, and pulls the moving jaw 130 into the fixed jaw 120.

Another novel aspect of the invention is the use of spring washers with 180 with an adjustment screw 185. To compensate and correct the fixed jaw 120 profile for individual system conditions, line 210 variations, and wear due to normal usage. The illustrated embodiment includes two adjustment screws 185 for each individual brake 240, but any number of adjustment screws 185 can be used depending on the size of the line brake 100, individual brakes 240, line 210 material, or operating conditions.

In the preferred embodiment, all the jaws and brake components are 6061 T6 grade extrusions, spacer plates are 6061 Aluminum plate, all components related to the pusher are steel and aluminum, the outer shell is of the brake is steel, and all hardware is Grade 5 or better.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

We claim:

1. A line brake comprising:
a frame;
a fixed jaw having a clamping surface;
a moveable jaw comprising:
a jaw slot; and
a guide rod;
a biasing element;
a pusher; and
an activator.

2. The line brake of claim 1 wherein the moveable jaw has a path of movement, the path of movement being oblique to the fixed jaw clamping surface.

3. The line brake of claim 2 further comprising an adjustment screw.

4. The line brake of claim 3 wherein the clamping surface has a groove.

5. The line brake of claim 4 wherein the pusher has a path of movement, the pusher movement path being parallel to the moveable jaw movement path.

6. The line brake of claim 4 further comprising a line path and wherein the biasing element comprises a longitudinal axis, the line path and biasing element longitudinal axis being parallel.

7. The line brake of claim 6 wherein the fixed jaw clamping surface, biasing element longitudinal axis, and line path are parallel.

8. The line brake of claim 1 wherein the line brake prevents a line from movement when the activator is in an inactivated state.

9. The line brake of claim 3 wherein the adjustment screw changes the position of the fixed jaw with respect to the frame.

10. The line brake of claim 4 wherein the pusher has a path of movement and the biasing element has a longitudinal axis, the pusher movement path being parallel to the biasing element longitudinal axis.

11. A hoist brake comprising:
a frame;
a plurality of line brakes of claim 1 arranged vertically;
an activator bar;
wherein the activator bar engages the plurality of pushers.

12. A line brake comprising:
a frame;
a fixed jaw having a clamping surface;
a moveable jaw:
a biasing element comprising a longitudinal axis;
a pusher;
an adjustment screw linking the fixed jaw and frame; and
an activator.

13. The line brake of claim 12 wherein the adjustment screw changes the position of the fixed jaw with respect to the frame

14. The line brake of claim 13 wherein the moveable jaw further comprises:
a jaw slot; and
a guide rod.

15. The line brake of claim 14 wherein the moveable jaw has a path of movement, the path of movement being oblique to the fixed jaw clamping surface.

16. The line brake of claim 14 wherein the clamping surface has a groove.

17. The line brake of claim 12 wherein the line brake prevents a line from movement when the activator is in an inactivated state.

18. The line brake of claim 12 further comprising a line path and wherein the line path and biasing element longitudinal axis are parallel.

19. The line brake of claim 18 wherein the fixed jaw clamping surface, biasing element longitudinal axis, and line path are parallel.

20. The line brake of claim 12 wherein the adjustment screw further comprises a spring washer.
